(19) United States
(12) Patent Application Publication
(10) Pub. No.: US 2025/0321804 A1
(43) Pub. Date: Oct. 16, 2025

(54) METHOD AND SYSTEM FOR MANAGING WORKLOAD PLACEMENT IN DIFFERENT ENVIRONMENTS

(71) Applicant: Dell Products L.P., Round Rock, TX (US)

(72) Inventors: Haijun Zhong, Shanghai (CN); Xue Qiang Zhou, Shanghai (CN); Ravikanth Chaganti, Bangalore (IN)

(21) Appl. No.: 18/635,586

(22) Filed: Apr. 15, 2024

(51) Int. Cl. G06F 9/50

(52) U.S. Cl. CPC G06F 9/505; G06F 9/5038; G06F 9/5083

(57) ABSTRACT

A method for managing workload placement includes: receiving, by an orchestrator, a workload placement request from a user, in which the request comprises at least a specification; invoking, by the orchestrator, an engine by sending the specification to obtain a placement rule; invoking, by the engine, a parser by sending the specification to obtain a domain-classified requirement; obtaining, upon the invoking by the engine and by the parser, a business requirement; generating, based on the business requirement and specification, and by the parser, the domain-classified requirement, in which the parser provides the domain-classified requirement to the engine; generating, based on the domain-classified requirement and by the engine, the placement rule, in which the engine provides the placement rule to the orchestrator; performing, based on the placement rule and by the orchestrator, the request; and initiating, by the orchestrator, notification of the user about a completion of the request.

### BACKGROUND

In a computing environment, orchestrators and schedulers are commonly used to distribute workload. Modern day systems must be capable of placing workloads on computing devices in complex infrastructures for data processing. Currently, there are no intelligent orchestrators that are aware of domain-classified requirements. Implementing an intelligent orchestrator may optimize the placement of workloads and improve the efficiency of a system.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1.1 shows a diagram of a system including multiple clients, multiple zones, and a management system in accordance with one or more embodiments of the invention.

FIG. 1.2 shows a diagram of an infrastructure node including multiple applications and computing resources in accordance with one or more embodiments of the invention.

FIG. 2 shows a diagram of placement domains in accordance with one or more embodiments of the invention.

FIG. 3.1 shows a flowchart of a method for obtaining inventory and capability information in accordance with one or more embodiments of the invention.

FIG. 3.2 shows a flowchart of a method for processing a workload placement request in accordance with one or more embodiments of the invention.

FIG. 3.3 shows a flowchart of a method for placing a workload based on the workload placement request in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regards to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of the figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, efficient placement of workload and application services across different environments (e.g., multi-cloud environments, hybrid cloud environments, etc.) is crucial to satisfy architectural characteristics (e.g., high-availability, fault tolerance, scalability, reliability, etc.). This placement requires considering various different factors such as, for example, fault domain requirements, workload resource requirements, service affinity and anti-affinity requirements, compliance and governance requirements, and user/consumer proximity requirements.

The aforementioned requirements may span one or more loosely related domains. For example, the fault domain requirements and workload resource requirements may fall into (or may be considered under) a hardware and infrastructure management domain. As yet another example, (i) the compliance and governance requirements and (ii) the service affinity and anti-affinity requirements may fall into (or may be considered under) an application orchestration and management domain. As yet another example, the user proximity requirements may fall into (or may be considered under) a business domain.

In most cases, conventional approaches (considering the aforementioned domains) perform workload placements across different environments based on user proximity. Further, these approaches do not offer dynamic and automatic workload placements based on the changes, for example, in the workload resource requirements and service affinity requirements. For example, Kubernetes uses labels and annotations such that a scheduler may make placement decisions based on one or more labels and topology requirements. However, in this example, an administrator must manually add these labels and annotations.

As yet another example, virtual machine (VM) managers employ built-in methods for affinity and anti-affinity based workload placements. However, in this example, the VM managers may be limited to virtualized workloads. The aforementioned approaches may operate well in silos but these approaches do not provide any unified representation that an orchestrator (or a scheduler) can enact. Separately, these approaches do not provide a unified view of placement decisions made across different domains.

For at least the reasons above discussed above, a fundamentally different approach/framework is needed (e.g., a framework that at least provides a unified way to represent the aforementioned requirements across different domains).

Embodiments of the invention relate to systems and methods for intelligently and efficiently placing workloads (e.g., production workloads) across different environments. As a result of the processes discussed below, one or more embodiments of the invention advantageously ensure that: (i) a definition of workload placement requirements/rules, decisions made to generate the workload placement rules, and a current state of a workload placement are considered and presented in a unified way; (ii) a method to translate workload requirements to a set of actionable placement rules (e.g., associated with on-premises, public cloud, and hybrid deployment scenarios) is provided in a unified manner (for an efficient placement of one or more workloads across the system); (iii) a unique hardware and/or software component (e.g., a parser) is provided, in which the parser can infer infrastructure, application, and business domains across the system and, using one or more pre-trained machine learning (ML) models, generate one or more placement requirements for a given workload (e.g., an application service); and/or (iv) another unique hardware and/or software component (e.g., a placement rule engine) is provided, in which the placement rule engine can transform the placement requirements into actionable rules to be provisioned.

The following describes various embodiments disclosed herein.

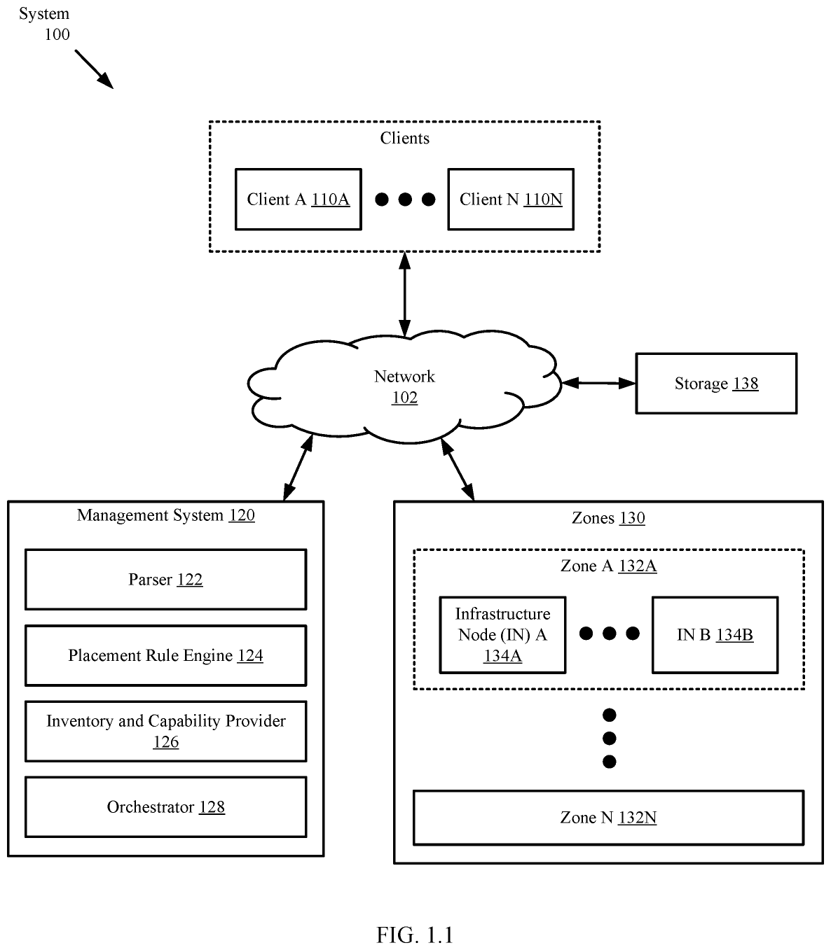

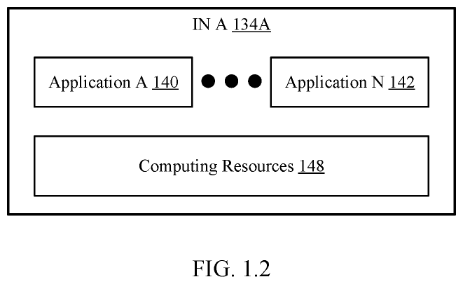

FIG. 1.1 shows a diagram of a system (100) in accordance with one or more embodiments of the invention. The system may include a network (102), multiple clients (110A, 110N), a management system (120), a storage (138), and multiple zones (130). The system may include additional, fewer, and/or other components without departing from the invention. Each of the components in the system may be operatively connected via any combination of wireless and/or wired connections. Each of the aforementioned components of the system (100) is discussed below.

In one or more embodiments, the network (102) is a network that performs the functionality of allowing communication between components of the system (100) described throughout this application. As used herein, a network (e.g., 102) may refer to an entire network or any portion thereof (e.g., a logical portion of the devices within a topology of devices). A network may include a data center network, wide area network, local area network, wireless network, cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments, although shown separately in FIG. 1.1, the network (102) may include any number of network devices (not shown) within any components (e.g., 110A, 110N, 120, 130, 138) of the system (100), as well as devices external to or between such components of the system (100). A network device may include any other components without departing from the scope of the invention. Examples of a network device include, but are not limited to, a network switch, router, multilayer switch, fiber channel device, an InfiniBand® device, etc. A network device is not limited to the aforementioned specific examples.

The network (102) may host any number of devices within any components of the system (100), as well as devices external to or between such components of the system (100). The network (102) provides the operative connectivity between the clients (110A, 110N), the management system (120), the zones (130), and the storage (138). Each of the aforementioned system components connected by the network (102) will be described in detail below.

In one or more embodiments, the clients (110A, 110N) are implemented as computing devices. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of a client of the clients (110A, 110N) as described throughout this application.

In one or more embodiments, a client of the clients (110A, 110N) is implemented as a logical device. The logical device may utilize the computing resources of any number of computing devices and thereby provide the functionality of the client as described throughout this application.

In one or more embodiments, the management system (120) manages the placement of a workload across the infrastructure nodes (134A, 134B) in one or more of zones (e.g., Zone A (132A), Zone N (132N), etc.). The management system (120) includes, at least, a parser (122), a placement rule engine (124), an inventory and capability provider (126), and an orchestrator (128). The management system (120) may include additional, fewer, and/or different components without departing from the scope of the invention. Each of the aforementioned components of the management system (120) is discussed below.

As used herein, a “workload” is a physical or logical component configured to perform certain work functions. Workloads may be instantiated and operated while consuming computing resources allocated thereto. A user (e.g., of a client) may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system data, etc.), medium workloads with higher priority (e.g., VM with FS data, network data management protocol (NDMP) data, etc.), large workloads with critical priority (e.g., mission critical application data), etc.

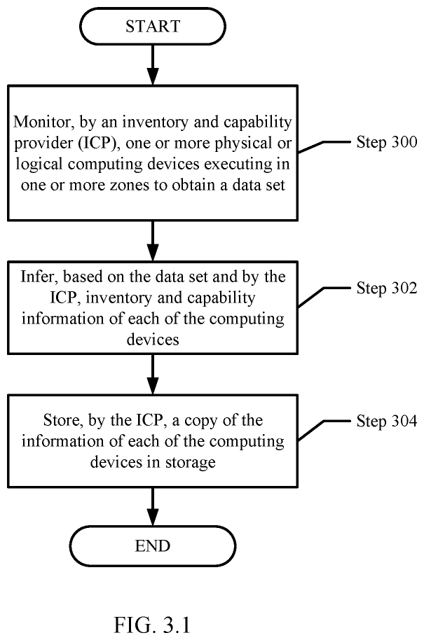

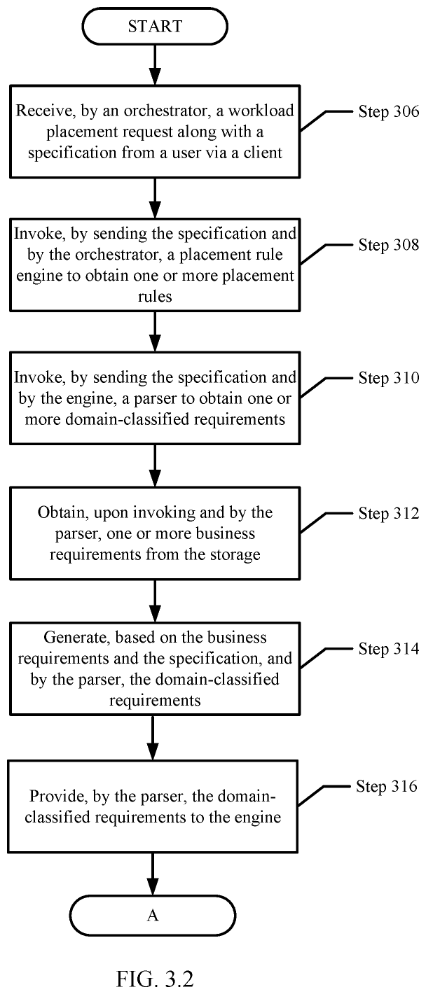

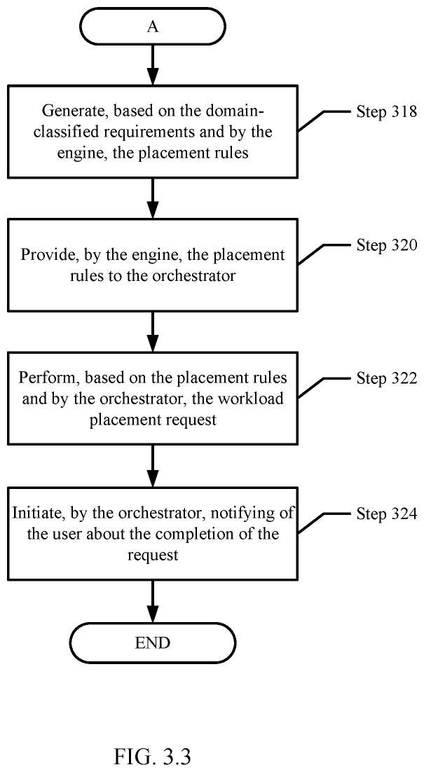

In one or more embodiments, the parser (122) transforms resource related and workload related parameters from a workload placement request into sets of domain-classified requirements. Domain-classified requirements refer to requirements that infrastructure nodes (134A, 134B) need to meet in order for a workload to be placed by the orchestrator (128). The parser (122) analyzes information gathered on the infrastructure nodes (134A, 134B) by the inventory and capability providers (ICP) (126) discussed below and analyzes it using generative artificial intelligence (AI) models in order to generate the requirements for the orchestrator (128). Additional information on the functionality of the parser may be found, for example, in FIG. 3.2.

One of ordinary skill will appreciate that the parser (122) may perform other functionalities without departing from the scope of the embodiments disclosed herein. The parser (122) may be implemented using hardware (e.g., a physical device including circuitry), software, or any combination thereof.

In one or more embodiments, the placement rule engine (124) uses domain-classified requirements to generate placement rules for the placement of workloads on the infrastructure nodes (134A, 134B). Placement rules refer to rules generated by the placement rule engine (124) and provided to the orchestrator (128) that dictate where workloads will be placed. The placement rule engine (124) effectively chooses where to place the workloads based on the information gathered by the ICP (126) and using generated requirements from the parser (122). The placement rule engine (124) communicates directly with the orchestrator (128) to provide placement rules. Additional information on the functionality of the placement rule engine may be found, for example, in FIGS. 3.2-3.3.

One of ordinary skill will appreciate that the placement rule engine (124) may perform other functionalities without departing from the scope of the embodiments disclosed herein. The placement rule engine (124) may be implemented using hardware, software, or any combination thereof.

In one or more embodiments, the ICP (126) continuously monitors the infrastructure nodes (134A, 134B) in the plurality of zones (130) in order to aggregate inventory, classify the infrastructure nodes (134A, 134B), and determine connection topology and fault domains in the zones (130). Connection topology refers to the connectivity of the clients (110A, 110N) and the infrastructure nodes (134A, 134B) over the network (102). The ICP (126) is responsible for retrieving information needed to make a placement decision and stores the information in the storage (138), as described below. More information on the functionality of the ICP may be found, for example, in FIG. 3.1.

One of ordinary skill will appreciate that the ICP (126) may perform other functionalities without departing from the scope of the embodiments disclosed herein. The ICP (126) may be implemented using hardware, software, or any combination thereof.

In one or more embodiments, the orchestrator (128) is responsible for making intelligent decisions about a workload placement. The orchestrator (128) receives workload placement requests from the clients (110A, 110N) and intelligently places the workloads specified in the requests on the infrastructure nodes. In the context of this invention, the orchestrator (128) performs dynamic placements based on the most up-to-date domain-classified requirements, including infrastructure, application, and business requirements. Additional information on the functionality of the orchestrator can be found, for example, in FIGS. 3.2 and 3.3.

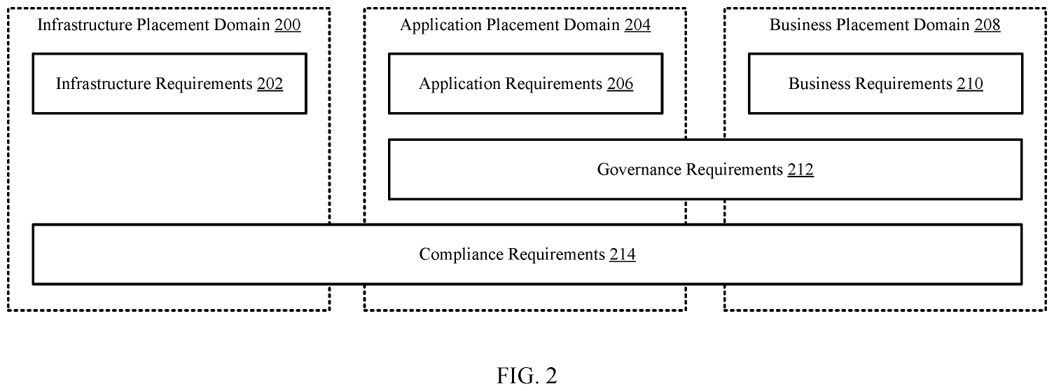

In one or more embodiments, infrastructure requirements may refer to, but are not limited to, fault domain requirements, network topology requirements, infrastructure capability requirements, and resource constraints, etc. Application requirements may refer to, but are not limited to, predictability requirements, scalability requirements, affinity and anti-affinity requirements, resource requirements, etc. Business requirements may include, but are not limited to, user proximity and location requirements, cost and budget requirements, criticality requirements, etc. Additional detail on domain-classified requirements can be found, for example, in FIG. 2.

One of ordinary skill will appreciate that the orchestrator (128) may perform other functionalities without departing from the scope of the embodiments disclosed herein. The orchestrator (128) may be implemented using hardware, software, or any combination thereof.

In one or more embodiments, the zones (130) may refer to geographical locations containing a multitude of infrastructure nodes (134A, 134B). As used herein, “zones” may refer to different types of infrastructures, including on premise data centers, co-located data centers, public cloud regions, multi-cloud, and hybrid cloud infrastructures. Each of these infrastructure types may have multiple infrastructure nodes, described at length, for example, in FIG. 1.2.

In one or more embodiments, the storage (138) may include a plurality of storage devices without departing from the scope of the invention. The storage (138) may include the functionality to, but is not limited to, provide storage services to the clients (110A, 110N) and the infrastructure nodes (134A, 134B). Items such as files, file systems, inventory and capability information for the infrastructure nodes (134A, 134B), or a plurality of other documents may be stored in the storage (138). The storage services may include the functionality to provide and/or obtain other services without departing from the scope of the invention. The storage (138) may include any number of storage devices without departing from the scope of the invention.

In one or more embodiments, the storage (138) is implemented as a computing device. A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device it causes the computing device to perform the functionality of the storage (138) as described throughout this application.

In one or more embodiments, the storage (138) is implemented as a logical device. The logical device may utilize the computing resources of any number of computing devices and thereby provide the functionality of the storage (138) as described throughout this application.

Turning now to FIG. 1.2, FIG. 1.2 shows a diagram of an infrastructure node (IN) (e.g., IN A (134A)) in accordance with one or more embodiments of the invention. IN A (134A) may include a plurality of applications (140, 142) and computing resources (148). IN A (134A) may be capable of fulfilling workload requests based on, but not limited to, the capability of the node to fulfill the requests with its currently available computing resources (148). IN A (134A) may include additional, fewer, and/or different components without departing from the scope of the invention. Each of the aforementioned components of IN A (134A) is discussed below.

In one or more embodiments, each application (140, 142) may refer to at least one application that may exist on IN A (134A) and may perform a variety of functionalities for IN A (134A). Functionalities of the applications may include, but not limited to, performing one or more tasks, managing data (e.g., reading data, writing data, collecting data, etc.), etc.

In one or more embodiments, the computing resources (148) may refer to hardware and/or software elements of IN A (134A) that may be available or unavailable to manage workloads. The computing resources (148) may include, but are not limited to, resources such as storage/memory resources (e.g., Flash memory, virtualized storage, etc.), processing resources (e.g., a central processing unit (CPU), a graphics processing unit (GPU), etc.), networking resources (e.g., a network adapter, a network interface card, etc.), virtualization resources (e.g., a virtual server, a container, a VM, a virtual storage pool, etc.), etc. The computing resources (148) available to IN A (134A) (and/or other INs in the system (e.g., 100, FIG. 1.1)) may be dependent on the amount of services placed on the applications (140, 142) at any given time.

Turning now to FIG. 2, FIG. 2 shows a diagram of an infrastructure placement domain (200), an application placement domain (204), and a business placement domain (208) in accordance with one or more embodiments of the invention. Each infrastructure placement domain (200, 204, 208) may include a plurality of requirements, described at length below. Each domain contains domain-classified requirements and compliance requirements (214). Governance requirements are included in the application and placement domains (204, 208). The placement domains (200, 204, and 208) may include additional, fewer, and/or different requirements without departing from the scope of the invention. Each of the aforementioned requirements of the placement domains (200, 204, and 208) is discussed below. Additional information on the implementation of the domains can be found, for example, in FIG. 3.2.

In one or more embodiments, the infrastructure placement domain (200) includes one or more infrastructure requirements (202) and one or more compliance requirements (214). The compliance requirements (214) are discussed at length below. The infrastructure requirements (202) relate to the inventory and capabilities of the infrastructure nodes (e.g., 134A, 134B, FIG. 1.1) in each zone (e.g., 132A, 132N, FIG. 1.1). The infrastructure requirements (202) may include, but are not limited to, fault domain requirements, network topology requirements, infrastructure capability requirements, and resource constraints, etc. An example of an infrastructure requirement may be that a service in a workload request may require at least a certain amount of memory, at least a certain amount of bandwidth, and/or a certain amount of storage.

Fault domains may represent servers or other entities that are more likely to fail. Fault domain requirements may refer to the fault tolerance of a system and its ability to stay online even if one or more servers experiences a failure. Infrastructure capability requirements and resource constraints may be related to the available computing resources of an infrastructure node. Infrastructure capability requirements may refer to the types of VMs and other services required to process workloads. The infrastructure capability requirements are related to the inventory from all infrastructure nodes (e.g., 134A, 134B, FIG. 1.1) across all available zones (e.g., 132A, 132N, FIG. 1.1) Resource constraints may refer to a required amount of computing resources (e.g., 148, FIG. 1.2) in an infrastructure node (e.g., 134A, FIG. 1.2) that is available to process a workload. Additional information on the implementation of the infrastructure requirements (202) can be found, for example, in FIG. 3.2.

In one or more embodiments, the application placement domain (204) includes one or more application requirements (206), at least a portion of governance requirements (212), and at least a portion of compliance requirements (214). The governance requirements (212) and compliance requirements (214) are discussed at length below. The application requirements (206) relate to the workload placement of application services. The application requirements (206) may include, but are not limited to, predictability requirements, scalability requirements, affinity and anti-affinity requirements, resource requirements, etc. A predictability requirement may specify the ability to anticipate the behavior and performance of the infrastructure nodes (e.g., 134A, 134B, FIG. 1.1) when workloads are placed on them. A scalability requirement may specify a minimum number of instances of a workload required to be implemented in order to generate at least one fault domain. An affinity requirement may specify at least a placement rule, which specifies placing a workload geographically closer to a second workload to minimize latency between the workload and the second workload. An anti-affinity requirement may specify a placement rule, which specifies placing a workload geographically distant to a second workload to prevent being the workload and the second workload located in a same fault domain. A resource requirement may specify an amount of computing resources, whether hardware or software, required to manage the workload. Additional information on the implementation of the application requirements (206) can be found, for example, in FIG. 3.2.

In one or more embodiments, the business placement domain (208) includes one or more business requirements (210), at least a portion of the governance requirements (212), and at least a portion of the compliance requirements (214). The business requirements (210) relate to the consumption of the service provided by the infrastructure nodes (e.g., 134A, 134B, FIG. 1.1 to the clients (e.g., 110A, 110N, FIG. 1.1). The business requirements may include, but are not limited to, user proximity and location requirements, cost and budget requirements, criticality requirements, etc. User proximity refers to placing related workload instances close together. It may be required for workloads to be placed on infrastructure nodes (e.g., 134A, 134B, FIG. 1.1) that are geographically close to each other. Cost and budget requirements may include restrictions on the amount of money that is available to spend on hardware or software required to process workload placed on the infrastructure nodes (e.g., 134A, 134B, FIG. 1.1). Criticality requirements may refer to requirements that instruct the system to prioritize certain tasks over others based on their importance. Additional information on the implementation of the business requirements (210) can be found, for example, in FIG. 3.2.

In one or more embodiments, the governance requirements (212) include requirements specific to the organization that the system (e.g., 100, FIG. 1.1) is associated with. The governance requirements (212) pertain to enforcing decisions and standards within the organization itself. The governance requirements (212) are included in the application placement domain (204) and the business placement domain (208). Additional information on the implementation of the governance requirements (212) can be found, for example, in FIG. 3.2.

In one or more embodiments, the compliance requirements (214) include requirements that lead all devices in an organization to comply to applicable policies, laws, and/or standards. An example of a law that many organizations around the world comply to is the General Data Protection Regulation (GDPR). The GDPR outlines a series of standards that both organizations and individuals are required to meet in the contexts of data privacy and data security. The compliance requirements (214) are included in the infrastructure domain (200), the application placement domain (204), and the business placement domain (208).

Additional information on the implementation of the compliance requirements (214) can be found, for example, in FIG. 3.2.

Turning now to FIG. 3.1, FIG. 3.1 shows a flowchart of a method for obtaining inventory and capability information in accordance with one or more embodiments of the invention. The method may be performed by, for example, the ICP (e.g., 126, FIG. 1.1). Other components of the system illustrated in FIG. 1.1 may perform all, or a portion, of the method of FIG. 3.1 without departing from the scope of the invention.

While FIG. 3.1 is illustrated as a series of steps, any of the steps may be omitted, performed in a different order, include additional steps, and/or perform any or all of the steps in a parallel and/or partially overlapping manner without departing from the scope of the invention.

In Step 300, one or more physical or logical computing devices are monitored by the ICP in order to obtain a data set. The computing devices may be, in the context of this invention, multiple infrastructure nodes in multiple zones (e.g., IN A (e.g., 134A, FIG. 1.1) and IN B (e.g., 134B, FIG. 1.1) in Zone A (e.g., 132A, FIG. 1.1)). The data set obtained by the ICP during the monitoring may include information such as, but not limited to, device connectivity and system topology information about the infrastructure nodes in the zones.

In Step 302, inventory and capability information of each of the computing devices is inferred by the ICP based on the data set obtained in Step 300. The ICP infers information about the computing devices such as which devices are/include GPU-capable servers, high-drive density servers, high-throughput network fabric, etc. The inventory and capability information may include, but is not limited to, a type of a VM, a service provided by a computing device, information with respect to a region of a computing device, cost of hardware or software required to provide a service(s), etc. Using the device connectivity and system topology information from Step 300, the ICP may determine at least (i) the connection topology among the infrastructure nodes and (ii) fault domains supported by the infrastructure nodes.

In Step 304, a copy of the inventory and capability information of each of the computing devices is stored in storage (e.g., 138, FIG. 1.1) by the ICP. The inventory and capability information (inferred in Step 302) may be used to generate domain-classified requirements for a placement rule engine (e.g., 124, FIG. 1.1) in the future, in order to make workload/application placement decisions.

In one or more embodiments, the method may end following Step 304.

Turning now to FIG. 3.2, FIG. 3.2 shows a flowchart of a method for processing a workload placement request in accordance with one or more embodiments of the invention. The method may be performed by, for example, the orchestrator (e.g., 128, FIG. 1.1), the placement rule engine, and the parser (e.g., 122, FIG. 1.1). Other components of the system illustrated in FIG. 1.1 may perform all, or a portion, of the method of FIG. 3.2 without departing from the invention.

While FIG. 3.2 is illustrated as a series of steps, any of the steps may be omitted, performed in a different order, include additional steps, and/or perform any or all of the steps in a parallel and/or partially overlapping manner without departing from the invention.

In Step 306, the orchestrator receives a workload placement request (associated with a workload) from a user via a client (e.g., 110A, FIG. 1.1). The workload placement request includes a specification from the user. The specification specifies at least one resource related parameter and at least one workload related parameter. The resource related parameter and workload related parameter may be dependent on computing resources available in an infrastructure node that may be chosen as a place to process/deploy the workload specified the request.

In one or more embodiments, the resource related parameter may specify, for example (but not limited to): a virtual GPU (vGPU) count required to perform a workload, a type of a vGPU scheduling policy, a type of a GPU virtualization approach that needs to be implemented, a virtual CPU (vCPU) count required to perform a workload, a virtual NIC (vNIC) count required to perform a workload, etc.

In one or more embodiments, the workload related parameter may specify, for example (but not limited to): a scalability requirement, an affinity requirement, an anti-affinity requirement, a governance requirement, a compliance requirement, etc. A scalability requirement may specify a minimum number of instances of a workload required to be implemented in order to generate at least one fault domain. An affinity requirement may specify at least a placement rule, which specifies placing a workload geographically closer to a second workload to minimize latency between the workload and the second workload. An anti-affinity requirement may specify a placement rule, which specifies placing a workload geographically distant to a second workload to prevent being the workload and the second workload located in a same fault domain. A governance requirement specify a framework that needs to be implemented by an organization while placing a workload in order to achieve a predetermined business goal. A compliance requirement may be a rule that complies with the GDPR.

In Step 308, the orchestrator invokes the placement rule engine. In one or more embodiments, the orchestrator may invoke the engine to obtain one or more placement rules from the specification sent by the client in Step 306. The placement rules are determined from the specification by the placement rule engine.

In Step 310, the placement rule engine invokes the parser by sending the specification. In one or more embodiments, the placement rule engine may invoke the parser to obtain one or more domain-classified requirements.

In Step 312, upon the invoking (in Step 310), the parser obtains one or more business requirements from the storage. The business requirements may be, but are not limited to, business domain requirements, governance requirements, or compliance requirements. An example of a business requirement may be that data at rest must be encrypted, user perceived response time must be shorter than a certain amount of time, or that the operational cost must not exceed a certain amount of money.

In Step 314, based on the requirements (obtained in Step 312) and the specification (obtain in Step 306), the parser generates domain-classified requirements. In one or more embodiments, the parser may use a generative AI model that may be pre-trained on previous workload placement requests or specifications received from clients. The domain-classified requirements may also be assigned a weight that determines the importance of each requirement. For example, requirements like resource constraints and cost constraints are weighted highly in order to override other domain-classified requirements in the final deployment of the placement rules discussed below. An example of an infrastructure requirement may be that a service in a workload request may require at least a certain amount of memory, at least a certain amount of bandwidth, and/or a certain amount of storage. An example of an application requirement may be that services must be highly available, must be able to horizontally scale, and/or must be able to scale to zero.

In Step 316, the parser provides the domain-classified requirements generated to the placement rule engine. The method continues in Step 318 of FIG. 3.3.

Turning now to FIG. 3.3, FIG. 3.3 shows a flowchart of a method for placing a workload based on a workload placement request in accordance with one or more embodiments of the invention. The method may be performed by, for example, the orchestrator and the placement rule engine. Other components of the system illustrated in FIG. 1.1 may perform all, or a portion, of the method of FIG. 3.3 without departing from the invention.

While FIG. 3.3 is illustrated as a series of steps, any of the steps may be omitted, performed in a different order, include additional steps, and/or perform any or all of the steps in a parallel and/or partially overlapping manner without departing from the invention.

In Step 318, the engine generates one or more placement rules. The placement rules are based on the domain-classified requirements generated by the parser in Step 314 of FIG. 3.2. As discussed in Step 314 of FIG. 3.2, the domain-classified requirements are weighted. The placement rule engine will identify which domain-classified requirements are the most heavily weighted and therefore are the most important for the workload placement request. Based on weighting, the placement rule engine will create an ordered set of requirements. The placement rule engine implements a business grammar analyzer to transform the domain-classified requirements into actionable rules. Depending on the ordered set of domain-classified requirements, the placement rule engine may identify/specify the placement rules to place the workload on corresponding infrastructure nodes.

In Step 320, the engine provides the placement rules to the orchestrator.

In Step 322, based on the placement rules, the orchestrator performs the workload placement request. In one or more embodiments, depending on the placement rules, the workload may be distributed to on-premise data centers, co-located data centers, public cloud regions, multi-cloud, and hybrid cloud environments.

In Step 324, the orchestrator initiates notifying of the user (of the client that issued the workload placement request) to indicate that the request has been completed. In one or more embodiments, the user may be notified via a graphical user interface (GUI) of the client.

In one or more embodiments, the method may end following Step 324.

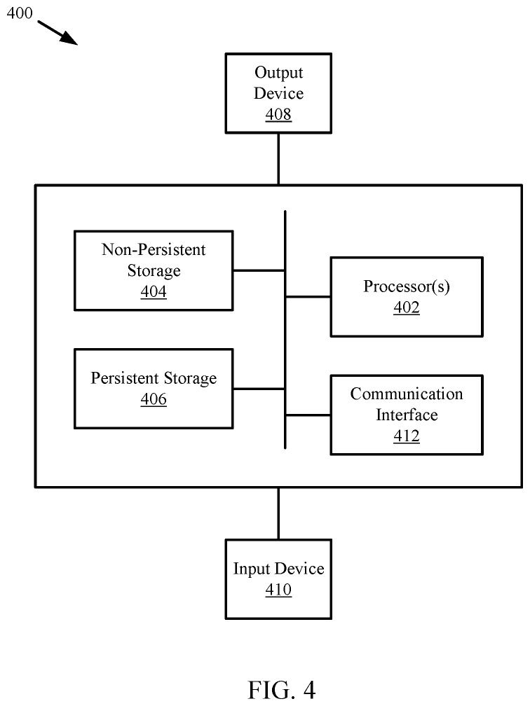

As discussed above, embodiments of the invention may be implemented using computing devices. Turning now to FIG. 4, FIG. 4 shows a diagram of a computing device in accordance with one or more embodiments of the invention. The computer (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth® interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) (402) may be one or more cores or micro-cores of a processor. The computer (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computer (400) may include one or more output devices (408), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many diverse types of computing devices exist, and the aforementioned input and output device(s) may take other forms.

One or more embodiments of the invention may be implemented using instructions executed by one or more processors of the system including clients, multiple zones with multiple infrastructure nodes each, a management system, and storage. Further, such instructions may correspond to computer readable instructions that are stored on one or more non-transitory computer readable mediums.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for managing workload placement, the method comprising:
receiving, by an orchestrator, a workload placement request from a user via a client, wherein the workload placement request comprises at least a specification;
invoking, by the orchestrator, an engine by sending the specification to obtain a placement rule;
invoking, by the engine, a parser by sending the specification to obtain a domain-classified requirement;
obtaining, upon the invoking by the engine and by the parser, a business requirement;
generating, based on the business requirement and the specification, and by the parser, the domain-classified requirement, wherein the parser provides the domain-classified requirement to the engine;
generating, based on the domain-classified requirement and by the engine, the placement rule, wherein the engine provides the placement rule to the orchestrator;
performing, based on the placement rule and by the orchestrator, the workload placement request; and
initiating, by the orchestrator, notification of the user about a completion of the workload placement request.

2. The method of claim 1, wherein the specification specifies at least a resource related parameter for a resource and a workload related parameter, wherein the resource is a central processing unit (CPU), a graphics processing unit (GPU), a data processing unit (DPU), memory, or a network source.

3. The method of claim 2, wherein the resource related parameter specifies at least one selected from a group consisting of a virtual graphics processing unit (vGPU) count required to perform the workload, a type of a vGPU scheduling policy, a type of a GPU virtualization approach that needs to be implemented, a virtual central processing unit (vCPU) count required to perform the workload, and a virtual network interface card (vNIC) count required to perform the workload.

4. The method of claim 2, wherein the workload related parameter specifies at least one selected from a group consisting of a scalability requirement, an affinity requirement, an anti-affinity requirement, a governance requirement, and a compliance requirement.

5. The method of claim 1, wherein the orchestrator performs the workload placement request by placing the workload on a first physical computing device executing in a first zone, wherein the workload is a set of microservices.

6. The method of claim 5,
wherein the first zone, a second zone, and a third zone form a heterogeneous environment,
wherein the second zone is a cloud environment and executes a logical computing device,
wherein the first zone, the second zone, and the third zone are distinct zones, and
wherein the first zone is operably connected to the third zone over a network.

7. The method of claim 6, further comprising:
prior to receiving the workload placement request:
monitoring, by an inventory and capability provider (ICP), the first physical computing device executing in the first zone and a second physical computing device executing in the second zone to obtain a data set, wherein the data set comprises at least hardware resource set information of the first physical computing device and a network topology relationship between the first zone and the second zone;
inferring, based on the data set and by the ICP, inventory and capability information associated with each of the first physical computing device and the second physical computing device; and
storing, by the ICP, a copy of the inventory and capability information in storage.

8. The method of claim 7, wherein, after obtaining the inventory and capability information from the storage, the engine converts the domain-classified requirement to the placement rule using the inventory and capability information.

9. The method of claim 7, wherein the first zone is a first geographic region in the world, wherein the second zone is a second geographical region in the world.

10. A system comprising:
a management system comprising at least an orchestrator, a parser, and an engine, wherein the management system is configured to execute a method for managing workload placement, the method comprising:
receiving, by the orchestrator, a workload placement request from a user via a client, wherein the workload placement request comprises at least a specification, wherein the management system is operably connected to the client over a network;
invoking, by the orchestrator, the engine by sending the specification to obtain a placement rule;
invoking, by the engine, a parser by sending the specification to obtain a domain-classified requirement;
obtaining, upon the invoking by the engine and by the parser, a business requirement;
generating, based on the business requirement and the specification, and by the parser, the domain-classified requirement, wherein the parser provides the domain-classified requirement to the engine;
generating, based on the domain-classified requirement and by the engine, the placement rule, wherein the engine provides the placement rule to the orchestrator;
performing, based on the placement rule and by the orchestrator, the workload placement request; and
initiating, by the orchestrator, notification of the user about a completion of the workload placement request.

11. The system of claim 10, wherein the specification specifies at least a resource related parameter for a resource and a workload related parameter, wherein the resource is a central processing unit (CPU), a graphics processing unit (GPU), a data processing unit (DPU), memory, or a network source.

12. The system of claim 11, wherein the resource related parameter specifies at least one selected from a group consisting of a virtual graphics processing unit (vGPU) count required to perform the workload, a type of a vGPU scheduling policy, a type of a GPU virtualization approach that needs to be implemented, a virtual central processing unit (vCPU) count required to perform the workload, and a virtual network interface card (vNIC) count required to perform the workload.

13. The system of claim 11, wherein the workload related parameter specifies at least one selected from a group consisting of a scalability requirement, an affinity requirement, an anti-affinity requirement, a governance requirement, and a compliance requirement.

14. The system of claim 13, wherein the scalability requirement specifies a minimum number of instances of the workload required to be implemented in order to generate at least one fault domain.

15. The system of claim 13, wherein the affinity requirement specifies at least a placement rule, wherein the placement rule specifies placing the workload geographically closer to a second workload to minimize latency between the workload and the second workload.

16. The system of claim 13, wherein the anti-affinity requirement specifies a placement rule, wherein the placement rule specifies placing the workload geographically distant to a second workload to prevent being the workload and the second workload located in a same fault domain.

17. The system of claim 13, wherein the governance requirement specifies a framework that needs to be implemented by an organization while placing the workload in order to achieve a predetermined business goal.

18. The system of claim 13, wherein the compliance requirement is a rule that complies with General Data Protection Regulations.

19. A non-transitory computer readable medium comprising computer readable program code, which when executed by a computer processor enables the computer processor to perform a method for managing workload placement, the method comprising:
receiving, by an orchestrator, a workload placement request from a user via a client, wherein the workload placement request comprises at least a specification;
invoking, by the orchestrator, an engine by sending the specification to obtain a placement rule;
invoking, by the engine, a parser by sending the specification to obtain a domain-classified requirement;
obtaining, upon the invoking by the engine and by the parser, a business requirement;
generating, based on the business requirement and the specification, and by the parser, the domain-classified requirement, wherein the parser provides the domain-classified requirement to the engine;
generating, based on the domain-classified requirement and by the engine, the placement rule, wherein the engine provides the placement rule to the orchestrator; and
performing, based on the placement rule and by the orchestrator, the workload placement request.

20. The non-transitory computer readable medium of claim 19,
wherein the specification specifies at least a resource related parameter for a resource and a workload related parameter, wherein the resource is a central processing unit (CPU), a graphics processing unit (GPU), a data processing unit (DPU), memory, or a network source; and
wherein the workload related parameter specifies at least one selected from a group consisting of a scalability requirement, an affinity requirement, an anti-affinity requirement, a governance requirement, and a compliance requirement.
